(19) United States
(12) Patent Application Publication
(10) Pub. No.: US 2009/0239056 A1
(43) Pub. Date: Sep. 24, 2009

(54) LUBRICATED ELECTRICALLY CONDUCTIVE GLASS FIBERS

(75) Inventors: Patrick Moireau, Curienne (FR); Claire Ceugniet, Saint Ours (FR); Claire Metra, Challes Les Eaux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN VETROTEX FRANCE S.A., Chambery (FR)

(21) Appl. No.: 11/577,774

(22) PCT Filed: Oct. 21, 2005
(86) PCT No.: PCT/FR05/50885

§ 371 Date: Jun. 1, 2009

(30) Foreign Application Priority Data
Oct. 21, 2004 (FR) 0452398

(51) Int. Cl. B32B 17/02; B32B 17/04; C03B 11/00; C08K 7/14

(52) U.S. Cl. 428/296.4; 428/392; 264/105; 428/391; 428/368; 428/378

(57) ABSTRACT

The present invention relates to glass strands coated with a sizing composition capable of conducting an electric current, which comprises at least one film-forming agent, at least one compound chosen from plasticizers, surfactants and dispersants, at least one coupling agent for coupling to the glass, and electrically conductive particles.

The glass strands according to the invention are more particularly intended for the production of electrically conductive parts by compression molding, said glass strands being employed in SMC or BMC form.

The present invention relates to glass strands coated with a size capable of conducting an electric current, said strands being intended to reinforce organic materials of the polymer type, so as to obtain composites.

The invention also relates to the sizing composition used to coat said strands, to the method for producing the composites from these strands, and to the resulting composites.

Conventionally, glass reinforcing strands are produced by mechanically attenuating molten glass streams flowing out from numerous orifices in a bushing filled with molten glass, under gravity, through the effect of the hydrostatic pressure due to the height of the liquid, in order to form filaments that are assembled into base strands, said strands then being collected on a suitable support.

During the attenuation, and before they are assembled into strands, the glass filaments are coated with a sizing composition, generally an aqueous composition, by passing them over a sizing member,

The size is essential on several counts,

During manufacture of the strands, it protects the filaments from the abrasion that results from them rubbing, at high speed, on the members for attenuating and wincing the strand by acting as a lubricant. The size also provides the strand with cohesion, by ensuring that the filaments are linked together. Finally, it makes the strand sufficiently integral to withstand the rewinding operations necessary for forming, in particular, “assembled” rovings from several case strands, and it also makes it possible for the electrostatic charges generated during these operations to be eliminated.

During use for the purpose of producing composites, the size improves the impregnation of the strand by the matrix to be reinforced and it promotes adhesion between the glass and said matrix, thus resulting in composites with improved mechanical properties. Furthermore, the size protects the strands from chemical and environmental attack, thereby helping to increase their durability. In applications requiring the strand to be chopped, the size prevents the filaments from splaying out and separating, and, together with the oversize, it contributes to dispersing the electrostatic charges generated during chopping.

The glass strands in their various forms (continuous, chopped or ground strands, mats, meshes, wovens, knits, etc.) are commonly used for the effective reinforcement of matrices of various types, for example thermoplastic or thermosetting organic materials and inorganic materials, for example cement.

The invention is applicable here to reinforcing strands that are incorporated into polymer matrices of the thermosetting type in order to manufacture either impregnated mats or SMCs (Sheet Molding Compounds), which may be formed directly by molding in a hot compression mold, or pastes intended to be molded using the BMC (Bulk Molding Compound) technique.

An SMC is a semifinished product in which a glass strand mat is combined with a paste of a thermosetting resin, in particular one chosen from polyesters.

In the SMC, the glass acts as reinforcement and provides the mechanical properties and dimensional stability of the molded parts. It generally represents 25 to 60% of the weight of the SMC. Usually, the glass is in the form of chopped strands, even though continuous strands may be used for some applications. The paste comprises the thermosetting resin and fillers, and optionally additives, such as initiators, viscosity regulators and mold release agents.

As is known, an SMC is manufactured by depositing a first paste layer on a film supported by a conveyor belt, by chopping strands unwound from rovings by means of a rosary chopper to a length of 12 to 50 millimeters on top of the resin, the strands being randomly (isotropically) distributed, and by depositing a second paste layer supported by a film, the resin face being turned toward the glass. The combination of the various layers then passes through the nip of one or more calendaring devices so as to impregnate glass strands with the resin and to remove the trapped air.

An SMC must also undergo a maturation treatment, for the purpose of increasing the viscosity of the resin, up to an imposed value of 40-100 Pa·s so as to allow it to be properly molded.

Molding with SMCs allows the production of individual parts, in medium or long runs, which are less expensive in particular owing to the fact that the SMC is deposited directly in the mold without it being required to cut it precisely to the dimensions thereof.

What distinguishes a BMC from an SMC is the form, which here is a paste intended to be injected into a compression mold.

The pares produced by these molding techniques are used in particular in the automotive field as a replacement for body parts or impact protection parts, which are currently made of metal, especially steel.

However, automobile manufacturers are constantly preoccupied with reducing the weight of vehicles as much as possible, so as to reduce the fuel consumption. To do this, it has been envisioned to substitute certain metal parts of the body with lighter parts made of composites.

The problem that arises with parts made of composites is that of painting.

The operation of painting metal parts is carried out on an industrial scale by cataphoresis. This consists in electrostatically depositing one or more primer coats in order to “smooth” the surface, and one or more paint coats.

Composite parts cannot be used as such as the polymer material is an electrical insulator. It is therefore necessary to make them conductive in order to be able to use them on conventional cataphoretic painting lines.

Solutions aiming to make composites electrically conductive have been disclosed.

U.S. Pat. No. 6,648,593 proposes, prior to application of the paint, to deposit a first coat of a conductive paint comprising a resin and conductive particles (in the form of whiskers), and a second metal coat applied without intervention of the electric current.

This solution requires the addition of other steps that are difficult to implement in the current process, and consequently it generates an additional cost.

WO-A-03/0 511 992 and US-A-2003/0 042 468 propose a composition intended to be used in molding processes, which comprises a crosslinkable prepolymer, at least one unsaturated monomer copolymerizable with the prepolymer, a copolymerization initiator and electrically conductive fillers, for example graphite, metal-coated particles or metal particles.

The processing of the composition is made difficult by the high conductive filler content needed to obtain a high level of conduction. Thus, the conductive fillers are incorporated directly into the matrix. This greatly increases the viscosity—impregnation of the glass strand is made more difficult and the pressure to be applied for molding has to be increased. The solution consisting in increasing the amount of solvent in order to reduce the viscosity has other drawbacks—it reduces the mechanical properties of the composite and generates microbubbles that impair the quality of the surface finish of the final parts.

The object of the present invention is to provide reinforcing strands that are particularly suitable for SMC production and are capable of conducting an electric current so as to obtain molded parts made of composites that can be cataphoretically treated.

One subject of the invention is glass strands coated with an aqueous sizing composition which comprises at least one film-forming agent, at least one compound, chosen from plasticizers, surfactants and dispersants, at lease one coupling agent for coupling to the glass and electrically conductive particles.

In the present invention, the expression “glass strands coated with a sizing composition that comprises . . . ” is understood to mean not only glass strands coated with the composition in question, such as those obtained immediately on leaving the sizing member(s), but also the same strands that have undergone one or more other subsequent treatments. Examples that may be mentioned include the drying treatment, for the purpose of removing water, and the treatments that lead to the polymerization/crosslinking of certain constituents of the sizing composition.

Again within the context of the invention, the term “strands” should be understood to mean the base strands resulting from the twist-free assembly of a multitude of filaments, and the products derived from these strands, especially assemblies of these base strands in the form of rovings. Such assemblies may be obtained by simultaneously paying out base strands from several packages and then assembling said strands into tows that are wound onto a rotating support. They may also be “direct” rovings with a titer (or linear density) equivalent to that of assembled rovings obtained by gathering the filaments directly beneath the bushing and winding onto a rotating support.

Also according to the invention, the expression “aqueous sizing composition” is understood to mean a composition that can be deposited on the filaments during attenuation, which composition is in the form of a suspension or dispersion comprising at least 70%, preferably 75%, by weight of water and possibly containing, where appropriate, less than 10%, preferably less than 5%, by weight of one or more essentially organic solvents helping to dissolve certain constituents of the sizing composition. In the majority of cases, the composition contains no organic solvent, especially so as to limit the emission of volatile organic compounds (VOCs) into the atmosphere.

The film-forming agent according to the invention acts in several ways: it gives the coating mechanical cohesion, by making the conductive particles adhere to the glass filaments and ensuring that these particles are linked together, where appropriate with the material to be reinforced; it helps to bind the filaments together; finally, it protects the strands from any mechanical damage and from chemical and environmental attack.

The film-forming agent is a polymer chosen from polyvinyl acetates (homopolymers or copolymers, for example vinyl acetate/ethylene copolymers), polyesters, epoxies, polyacrylics (homopolymers or copolymers), polyurethanes, polyamides (homopolymers or copolymers, for example polyamide/polystyrene or polyamide/polyoxyethylene block copolymers), cellulose polymers and blends of these compounds. Polyvinyl acetates, epoxies and polyurethanes are preferred.

The plasticizer lowers the glass transition temperature of the film-forming agent, giving the size flexibility and limiting shrinking after drying.

The surfactant improves the suspension and dispersion of the conductive particles and promotes compatibility between the other constituents and water. It may be chosen from cationic, anionic or nonionic compounds.

To avoid stability and ununiform particle dispersion problems in the sizing composition, it is preferred to use cationic or nonionic surfactants.

The dispersant helps to disperse the conductive particles in the water and to reduce their sedimentation.

The plasticizers, surfactants and dispersants may possess one or more functions specific to each of the abovementioned categories. The choice of these agents and the amount to be used depend on the film-forming agent and on the conductive particles.

These agents may especially be chosen from:
organic compounds, in particular:
   optionally halogenated, aliphatic or aromatic, polyalkoxylated compounds, such as ethoxylated/propoxylated alkylphenols, preferably containing 1 to 30 ethylene oxide groups and 0 to 15 propylene oxide groups, ethoxylated/propoxylated bisphenols, preferably containing 1 to 40 ethylene oxide groups and 0 to 20 propylene oxide groups, ethoxylated/propoxylated fatty alcohols, preferably the alkyl chain of which comprises 8 to 20 carbon atoms, and containing 2 to 50 ethylene oxide groups and up to 20 propylene oxide groups. These polyalkoxylated compounds may be block copolymers or random copolymers,
   polyalkoxylated fatty acid esters, for example polyethyleneglycol, the alkyl chain of which preferably comprises 8 to 20 carbon atoms, and containing 2 to 50 ethylene oxide groups and up to 20 propylene oxide groups and
   amine compounds, for example optionally alkoxylated amines, amine oxides, alkylamides, sodium, potassium or ammonium succinates and taurates, sugar derivatives, especially sorbitan, and sodium, potassium or ammonium alkyl sulfates and alkyl phosphates; and
inorganic compounds, for example silica derivatives, these compounds possibly being used by themselves or as a mixture with the aforementioned organic compounds.

The electrically conductive particles confer electrical conductivity on the glass strands and the level of performance depends on the amount of particles present on the strands. According to the invention, these are carbon-based particles, especially graphite and/or carbon black particles.

The origin of the graphite—natural or synthetic—has no appreciable impact on the electrical conductivity. It there fore does not matter whether one or other type of graphite, by itself or as a blend, is used.

The particles may have any shape—for example they may be spheres, flakes or needles. However, it has been found that the electrical conductivity of a blend of particles of different shapes is improved compared with the same amount of particles but of the same shape. Blends combining two shapes (binary blend) or three shapes (ternary blend) of particles prove to be advantageous.

Preferably, 30 to 60% of the conductive particles have a high aspect ratio (defined by the ratio of the longest dimension to the shortest), this ratio preferably varying from 5 to 20, especially around 10, and advantageously at least 15% of the particles are in the form of flakes or needles.

Like the shape, the size of the particles is an important parameter as regards electrical conductivity. As a general rule, the size of the particles taken along their longest dimension does not exceed 250 μm, preferably 100 μm.

It is advantageous to combine the aforementioned particles, generally made of graphite, with a carbon black powder that conducts electric current, with a particle size not exceeding 1 μm, preferably having a mean size of less than 100 nm. The carbon black particles, owing to their small size, create points of contact between the graphite particles, thereby further improving the electrical conductivity.

The coupling agent ensures that the size is attached to the surface of the glass.

The coupling agent is chosen from hydrolyzable compound, especially in acid medium containing, for example, citric acid or acetic acid, these compounds belonging to the group consisting of silanes, such as γ-glycidoxypropyltrimethoxysilane, γ-acryloxypropyltrimethoxysilane, γ-methacryloxypropyltrimethoxysilane, poly(oxyethylene/oxypropylene) trimethoxysilane, γ-aminopropyltriethoxysilane, vinyltrimethoxysilane, phenylaminopropyltrimethoxysilane or styrylaminoethylaminopropyltrimethoxysilane, siloxanes, titanates, zirconates and blends of these compounds. Preferably, silanes are chosen.

In addition to the aforementioned constituents that essentially contribute to the structure of the size, one or more other constituents may be present.

Thus, a viscosity regulator may be introduced, so as to adjust the viscosity of the composition to the conditions of applying the size to the filaments, in general this viscosity being between 5 and 80 mPa·s and preferably at least 7 mPa·s. This regulator also helps to stabilize the dispersion of particles so that they do not form a sedimented deposit too rapidly and do not migrate to the outside and lie on the surface of the package when winding the strand.

The viscosity regulator is chosen from highly hydrophilic compounds, that is to say those that are able to capture a large amount of water, such as carboxycethyl celluloses, guar or xanthan gums, carrageenans, alginates, polyacrylics, polyamides, polyethylene glycols, especially those with a molecular weight of greater than 100 000, and blends of these compounds.

The size may also include the usual additives for glass strands, namely lubricants, such as mineral oils, fatty esters, for example isopropyl palmitate or butyl stearate, alkylamines, complexing agents, such as EDTA and gallic acid derivatives, and antifoams, such as silicones, polyols and vegetable oils.

All of the abovementioned compounds contribute to the production of glass strands that can be easily manufactured, are able to be used as reinforcements, and which are incorporated without any problem into the resin coring manufacture of the composites and also possess electrical conduction properties.

As a general rule, the amount of size represents 2 to 7%, preferably 3.5 to 6%, of the weight of the final strand.

The conductive strand according to the invention may be made of glass of any kind, for example E-glass, C-glass, R-glass or AR-glass, and glass with a low boron content (less than 6%). E-glass and AR-glass are preferred.

The diameter of the glass filaments constituting the strands may vary widely, for example from 5 to 30 μm. Likewise, wide variations may occur in the linear density of the strand used, such as an assembled roving, tor which the linear density ranges from 68 to 4800 tex depending on the intended applications, this roving possibly being formed from base strands whose linear density varies from 17 to 320 tex.

Another subject of the invention is the sizing composition itself, before it has been deposited on the glass filaments. It comprises the aforementioned constituents and water.

The sizing composition comprises (in % by weight):
2 to 10%, preferably 3 to 8.5%, of at least one film-forming agent;
0.2 to 8%, preferably 0.25 to 6%, of at least one compound chosen from plasticizers, surfactants and dispersants;
4 to 25%, preferably 6 to 20%, of electrically conductive particles;
0.1 to 4%, preferably 0.15 to 2%, of at least one coupling agent;
0 to 4%, preferably 0 to 1.8%, of at least one viscosity regulator; and
0 to 6%, preferably 0 to 3%, of additives.

The amount of water to be used is determined so as to obtain a solids content that varies from 8 to 35%, preferably 12 to 25%.

The preparation of the sizing composition is carried out as follows:
a) producing a dispersion D of the conductive particles in water containing the dispersant;
b) introducing the other components of the size, namely the film-forming agents, the plasticizers, the surfactants, the coupling agents, in hydrolyzed form, and, where appropriate, the viscosity regulators and the additives, in water in order to form an emulsion E; and
c) blending the dispersion D with the emulsion E.

Advantageously, steps a) and c) are carried out with sufficient stirring to prevent the risk of sedimentation of the conductive particles.

When a viscosity regulator is used, it is introduced at step b) firstly in the form of an aqueous solution, where necessary heated to about 80° C. so that it dissolves more easily.

In general, the dispersion D is stable under the usual storage conditions at a temperature of 20 to 25° C. In particular, it may be used without major drawback over a period of about six months, where necessary stirring it before use if the particles have sedimented.

However, the sizing composition should be used almost immediately after it has been prepared, preferably within a period of time not exceeding about four days under the aforementioned storage conditions. As previously, the particles that have sedimented may be redispersed without the properties of the composition being affected thereby.

As mentioned previously, the aqueous solution is deposited on the filaments before they are assembled into base strand (s). The water is usually removed by drying the strands after collection.

Yet another subject of the invention is a composite, in particular an SMC or a BMC, in which at least one thermosetting polymer material is combined with reinforcing strands, said strands consisting partly or completely of glass strands coated with the sizing composition described above. The glass content in the composite is generally between 5 and 60% by weight.

According to a first embodiment, the composite is in the form of an SMC having a glass content of between 10 to 60%, preferably of 20 to 45%, by weight.

According no a second embodiment, the composite is in the form of a BMC having a glass content of between 5 to 20% by weight.

Preferably, the thermosetting polymer material is a phenolic resin.

A further subject of the invention is the use of the sized glass strands according to the invention for producing electrically conductive molded parts using the technique of compression molding, said strands being used in particular in SMC or BMC form.

As already mentioned, the molded parts can be painted on standard lines for applying paint cataphoretically, especially for the production of automobile parts.

Hitherto, it was considered that a part molded from an SMC or BMC could be coated with paint under the aforementioned conditions when it has in particular a surface resistivity of between 0.5 and 1.5 MΩ/□.

The inventors have discovered that a part having an “internal” resistivity, that is to say a volume resistivity as may be conferred by a layer of conductive fibers within the matrix, for example of the order of 0.01 to 1000 MΩ.m, could also be treated under the same conditions.

As a result, the size with which the glass strands are coated does not necessarily have to possess a high solubility in the matrix to be reinforced, so that the conductive particles are dispersed throughout the part in order that it can undergo the cataphoretic painting treatment. A size that is only slightly soluble in the matrix, for example containing one or more polyurethanes as film-forming agent, or even one that is insoluble, may consequently be suitable for applying paint to such molded parts.

The use of the conductive glass strand according to the invention is not limited to the SMC or BMC molding technique. More generally, the glass strands can be used in any technique for manufacturing composites involving a reinforcement in the form of glass strands that advantageously requires electrical conduction. In particular, the glass strands may be in the form of a mat or veil, especially one that can be used as an SMC surface coating or reinforcing element, said strands possibly being combined with other reinforcing strands, especially glass strands.

The strands according to the invention may thus be used in all fields in which it is desired to achieve thermal conduction and heat dispersion properties, for example in the domestic electrical appliance and automotive fields. These strands may also be used for

electromagnetic shielding applications, especially in the transport field, in particular in automobiles, in the building field and in fields requiring protection of electronic components, especially those relating to magnetic media for storing data.

The examples given below illustrate the invention without however limiting it.

In these examples, the following methods were used:
On the glass strand:
   [symbol] the loss on ignition of the sized glass strand was measured under the conditions in the ISO 1887 standard. This loss on ignition is given in %;
   [symbol] the flock was measured by making the tows, paid out from two rovings, pass simultaneously over a turn roll at a speed of 200 m/min. The flock is defined by the amount of fibrils obtained after a 3 kg mass of strand has unwound, and it is expressed in mg/100 g of strand;
   [symbol] the tenacity of the strand was determined by measuring the tensile breaking force under the conditions in the ISO 3341 standard. The tenacity is expressed in N/tex;
   [symbol] the linear resistivity, in MΩ/cm, was obtained by calculating it from the equation:

ρ=R/l
in which ρ is the resistivity in MΩ/cm
   R is the resistance in MΩ and
   l is the length of the fiber in cm,
the resistance R being measured using an ohmmeter and the distance between the two electrodes being 20 cm.
On the molded part:
   [symbol] the surface resistivity, in MΩ/□, was measured according to the NF EN 1149-1 standard;
   [symbol] the “internal” resistivity, in MΩ·m, was measured on a plaque, obtained according to the aforementioned NF EN 1149-1 standard, drilled with two holes 20 cm apart. A metal rivet (diameter: 4 mm) serving as connector was inserted into each hole, said connecters being connected to the electrodes of an ohmmeter. The internal resistivity was calculated from the equation:

ρ′=R′S/d
in which p′ is the internal resistivity, in MΩ·m
   R′ is the resistance, in MΩ
   S is the area of the plaque, in m² and
   d is the distance between the connectors;
[symbol] the flexural strength and the flexural modulus, in MPa, and the deflection, in mm, were measured under the conditions in the ISO 14125-1 standard; and
[symbol] the Charpy impact strength, in kJ/m², was measured under the conditions in the ISO 179-1 eU93 standard.

### EXAMPLE 1

A sizing composition was prepared that comprised (in % by weight:

film-forming agents:

| | |
|---|---|
| polyvinyl acetate⁽¹⁾ | 6.92 |
| polyvinyl acetate⁽²⁾ of 50000 molecular weight | 3.46 |
| epoxy resin⁽³⁾ | 2.40 |
| plasticizer: a blend of dipropylene glycol | 0.25 |
| dibenzoate and diethylene glycol dibenzoate⁽⁴⁾ | |
| cationic dispersant⁽⁵⁾ | 2.22 |
| antifoam⁽⁶⁾ | 0.28 |

conductive particles:

| | |
|---|---|
| carbon black powder⁽⁷⁾ | 2.37 |
| carbon black powder⁽⁸⁾ | 0.97 |
| (mean particle size: 50 nm) | |
| synthetic graphite powder⁽⁹⁾ | 7.77 |
| (particle size: 1-10 μm) | |

coupling agents:

| | |
|---|---|
| γ-methacryloxypropyltriethoxysilane⁽¹⁰⁾ | 0.29 |
| γ-aminopropyltriethoxysilane⁽¹¹⁾ | 0.19 |
| lubricant: polyethyleneimine salt⁽¹²⁾ | 0.59 |

The composition was prepared by adding the constituents to a vessel containing water at 80° C., it was kept vigorously stirred, the conductive particles being added last.

The composition had a viscosity of 7 mPa·s at 20° C. and a solids content of 19.2%.

The sizing composition was deposited on E-glass filaments 11 μm in diameter, before they were assembled into a single strand, which was wound into a cake,

The properties of this strand were the following:
linear density: 202 tex;
loss on ignition: 4.49%;
fuzz: 0.92 mg/100 g of strand;
tenacity; 0.659 N/tex; and
linear resistivity: 0.040 M Ω/cm (standard deviation: 0.015).

### EXAMPLE 2

This example was produced under the conditions of Example 1, but modified in that the sizing composition that was prepared comprised (in % by weight):

film-forming agents:

| | |
|---|---|
| polyvinyl acetate⁽¹⁾ | 3.48 |
| polyvinyl acetate⁽²⁾ of 50000 molecular weight | 1.73 |
| epoxy resin⁽³⁾ | 1.20 |
| plasticizer: a blend of dipropylene glycol | 0.12 |
| dibenzoate and diethylene glycol dibenzoate⁽⁴⁾ | |
| cationic dispersant⁽⁵⁾ | 2.96 |
| antifoam⁽⁶⁾ | 0.28 |

conductive particles:

| | |
|---|---|
| carbon black powder⁽⁸⁾ | 4.44 |
| (mean particle size: 50 nm) | |
| synthetic graphite powder⁽⁹⁾ | 10.36 |
| (particle size: 1-10 μm) | |

coupling agents:

| | |
|---|---|
| γ-methacryloxypropyltriethoxysilane⁽¹⁰⁾ | 0.15 |
| γ-aminopropyltriethoxysilane⁽¹¹⁾ | 0.10 |
| lubricant: polyethyleneimine salt⁽¹²⁾ | 0.30 |

The composition had a viscosity of 15 mPa·s at 20° C. and a solids content of 19.5%.

The properties of this strand were the following;
linear density: 200 tex;
loss on ignition: 5.80%;
fuzz: 0.53 mg/100 g of strand;
tenacity: 0.580 N/tex; and
linear resistivity: 0.015 M Ω/cm (standard deviation: 0.010).

### EXAMPLE 3

A sizing composition was prepared, under the conditions of Example 1, which comprised (in % by weight):

film-forming agents:

| | |
|---|---|
| polyvinyl acetate⁽¹⁾ | 5.15 |
| polyvinyl acetate⁽²⁾ of 50000 molecular weight | 2.57 |
| epoxy resin⁽³⁾ | 1.73 |
| plasticizer: a blend of dipropylene glycol | 0.18 |
| dibenzoate and diethylene glycol dibenzoate⁽⁴⁾ | |
| cationic dispersant⁽⁵⁾ | 2.60 |
| antifoam⁽⁶⁾ | 0.18 |

conductive particles:

| | |
|---|---|
| carbon black powder⁽⁸⁾ | 3.90 |
| (mean particle size: 50 nm) | |
| expanded synthetic graphite powder⁽¹³⁾ | 2.60 |
| in the form of flakes (particle size: 10-50 μm) | |
| synthetic graphite powder⁽⁹⁾ | 6.50 |
| (particle size: 1-10 μm) | |

coupling agents:

| | |
|---|---|
| γ-methacryloxypropyltriethoxysilane⁽¹⁰⁾ | 0.22 |
| γ-aminopropyltriethoxysilane⁽¹¹⁾ | 0.14 |
| lubricant: polyethyleneimine salt⁽¹²⁾ | 0.42 |

The composition had a viscosity of 12 mPa·s at 20° C. and a solids content of 20.2%.

The composition was applied to E-glass filaments 16 μm in diameter, which were assembled as four 100 tex strands that were wound directly beneath the bushing in the form of cakes comprising the four separate strands. After the cakes were dried, the strands extracted from the latter were rewound in the form of a 2400 tex assembled roving (six 4×100 tex cakes).

The properties of this strand were the following:
linear density: 100 tex;
loss on ignition: 4.40%;
fuzz: 0.125 mg/100 g of strand;
linear resistivity: 0.017 M Ω/cm (standard deviation: 0,009).

### EXAMPLE 4

This example was prepared under the conditions of Example 3, but modified in that the sizing composition comprised (in % by weight):

film-forming agents:

| | |
|---|---|
| polyvinyl acetate⁽¹⁾ | 7.21 |
| polyvinyl acetate⁽²⁾ of 50000 molecular weight | 3.60 |
| epoxy resin⁽³⁾ | 1.73 |
| plasticizer: a blend of dipropylene glycol | 0.18 |
| dibenzoate and diethylene glycol dibenzoate⁽⁴⁾ | |
| cationic dispersant⁽⁵⁾ | 2.70 |
| antifoam⁽⁶⁾ | 0.18 |

conductive particles:

| | |
|---|---|
| carbon black powder⁽⁸⁾ | 3.90 |
| (mean particle size: 50 nm) | |
| expanded synthetic graphite powder⁽¹³⁾ | 2.60 |
| in the form of flakes (particle size: 10-50 μm) | |
| synthetic graphite powder⁽⁹⁾ | 6.50 |
| (particle size: 1-10 μm) | |

coupling agents:

| | |
|---|---|
| γ-methacryloxypropyltriethoxysilane⁽¹⁰⁾ | 0.22 |
| γ-aminopropyltriethoxysilane⁽¹¹⁾ | 0.14 |
| lubricant: polyethyleneimine salt⁽¹²⁾ | 0.42 |

The composition had a viscosity of 14 mPa·s at 20° C. and a solids content of 21.6%.

The properties of this strand were the following:
linear density: 100 tex;
loss on ignition: 4.0%;
fuzz: 0.625 mg/100 g of strand;
linear resistivity: 0.034 M Ω/cm (standard
deviation: 0.013).

An SMC was produced from this strand in the following manner. Deposited in succession on a polyethylene film were: a first layer of unsaturated polyester resin paste; chopped glass strands (length: 25 mm); a second layer of the aforementioned paste; and a second polyethylene film, identical to the first.

The paste had the following composition (in parts by weight):

| | |
|---|---|
| polyester resin (M 0494 from Cray Valley) | 52 |
| filler: calcium carbonate | 200 |

polymerization catalysts:

| | |
|---|---|
| Trigonox ® 117 peroxide from Akzo | 1.1 |
| Trigonox ® 141 peroxide from Akzo | 0.1 |
| polyvinyl acetate (Fast Cure ® 9005 from Dow Chemicals) | 48 |
| inhibitor: p-benzoquinone | 0.06 |
| wetting agent/viscosity reducer (Byk ® 996 from Byk Chemie) | 1.3 |
| viscosity reducer (VR3 from Dow Chemicals) | 2.0 |
| mold release agent: zinc stearate | 2.0 |
| thickener: magnesium oxide | 2.4 |

The glass strands represented 30% by weight of the SMC composite.

The SMC was cut to a size slightly smaller than that of the mold and deposited in the latter after the polyethylene films had been removed. The molding operation was carried out at a temperature of 145° C. at a pressure of 70 bar, and a loading factor of 25%.

The molded part had the electrical and mechanical properties indicated in the following table. For comparison, this table also shows the properties of a part molded under the same conditions from an SMC composite comprising glass strands coated with a conventional, nonconductive, size (control specimen).

| | Ex. 4 | Control |
|---|---|---|
| Surface resistivity | 500 kΩ/□-100 MΩ/□ | not measurable |
| 3-point bending: | | |
| Strength (MPa) | 130-140 | 130-150 |
| Modulus (MPa) | 7000-9000 | 7000-9000 |
| Deflection (mm) | 3.00-3.80 | 3.25-4.00 |
| Charpy impact strength (kJ/m²) | 40-65 | 60-80 |

The molded part obtained from the strands according to the invention had a substantially better surface resistivity than the control, within the range of values required for electrostatic painting applications. It had mechanical properties in three-point bending that were equivalent to those of the control.

### EXAMPLE 5

A sizing composition was prepared, under the conditions of Example 3, which comprised (in % by weight);

film-forming agents:

| | |
|---|---|
| polyurethane⁽¹⁴⁾ | 16.80 |
| dispersant: polyetherphosphate⁽¹⁵⁾ | 6.68 |
| antifoam⁽⁶⁾ | 0.80 |

conductive particles:

| | |
|---|---|
| carbon black powder⁽⁸⁾ | 3.90 |
| (mean particle size: 50 nm) | |
| expanded synthetic graphite powder⁽¹³⁾ | 2.60 |
| in the form of flakes (particle size: 10-50 μm) | |
| synthetic graphite powder⁽⁹⁾ | 6.50 |
| (particle size: 1-10 μm) | |

coupling agents:

| | |
|---|---|
| γ-methacryloxypropyltriethoxysilane⁽¹⁰⁾ | 0.30 |
| γ-aminopropyltriethoxysilane⁽¹¹⁾ | 0.40 |

The composition had a viscosity of 35 mPa·s at 20° C. and a solids content of 22.4%.

The strand had a linear density of 91 tex and a loss on ignition of 4.7%.

A 1456 tex assembled roving (four 4×91 tex cakes) was produced from the strands extracted from the cakes.

The assembled rovings were used under the conditions of Example 4 to form an SMC.

The molded part had a surface resistivity of 1×10⁶ MΩ/□ and an internal resistivity of 1 MΩ·m.

### EXAMPLE 6

This example was prepared under the conditions of Example 5, but modified in that the sizing composition comprised (in % by weight):

film-forming agents:

| | |
|---|---|
| polyurethane⁽¹⁴⁾ | 16.80 |
| dispersant: polyetherphosphate⁽¹⁵⁾ | 6.68 |
| antifoam⁽⁶⁾ | 0.18 |

conductive particles:

| | |
|---|---|
| carbon black powder⁽⁸⁾ | 5.20 |
| (mean particle size: 50 nm) | |
| expanded synthetic graphite powder⁽¹³⁾ | 5.20 |
| in the form of flakes (particle size: 10-50 μm) | |
| synthetic graphite powder⁽⁹⁾ | 2.60 |
| (particle size: 1-10 μm) | |

coupling agents:

| | |
|---|---|
| γ-methacryloxypropyltriethoxysilane⁽¹⁰⁾ | 0.30 |
| γ-aminopropyltriethoxysilane⁽¹¹⁾ | 0.40 |

The composition had a viscosity of 15 mPa·s at 20° C. and a solids content of 22.4%.

The strand had a linear density of 96 tex and a loss on ignition of 4.5%.

An SMC was produced from this strand under the same conditions as for Example 4.

The molded part had a surface resistivity of 1×10⁵ MΩ/□ and an internal resistivity of 0.1 MΩ·m.

The molded parts of Examples 4 to 6 have lower surface resistivity values than the control based on a conventional, non electrically conductive, SMC.

The parts of Examples 5 and 6 also have a markedly lower internal resistivity than the control (internal resistivity greater than 10⁶ MΩ·m). The inventors attribute this effect to the fact that the film-forming agent present in the glass strand size is relatively insoluble in the matrix. Thus, the conductive particles remain on the strands, or in their immediate environment, and do not migrate to the surface of the part. The conducting network formed by the glass strands within the part gives an internal resistivity sufficient to permit it to be cataphoretically painted.
{1} Sold under the reference VINAMUL® 8828 by Vinamul (solids content: 52% by weight);
(2) Sold under the reference VINAMUL® 8852 by Vinamul (solids content: 55% by weight);
(3) Sold under the reference FILCO® 310 by COIM (solids content: 52% by weight);
(4) Sold under the reference K-FLEX® 500 by Noveon (solids content: 100% by weight);
(5) Sold under the reference SOLSPERSE® 2700 by Lubrizol Additives (solids content: 100% by weight);
(6) Sold under the reference TEGO® Foafex 830 by Tego (solids content: 100% by weight);
(7) Sold under the reference VULCAN® XC 72 by Cabot;
(8) Sold under the reference VULCAN® XC 72 R by Cabot;
(9) Sold under the reference SPF 17 by Ucar;
(10) Sold under the reference SILQUEST® A-174 by GE Silicones (solids content: 100% by weight);
(11) Sold under the reference SILQUEST® A-1100 by GE Silicones (solids content: 100% by weight);
(12) Sold under the reference EMERY® 6760 by Cognis (solids content: 17% by weight);
(13) Sold under the reference GRAFPOWDER® TG 407 by Ucar;
(14) Sold under the reference BAYBOND® PU 401 by Bayer (solids content: 40% by weight); and
(15) Sold under the reference TEGO Dispers® 651 by Tego Chemie (solids content: 100% by weight).

1. A glass strand coated with an electrically conductive sizing composition which comprises at lease one film-forming agent, at least one compound, chosen from plasticizers, surfactants and dispersants, at least one coupling agent for coupling to the glass and electrically conductive particles.

2. The glass strand as claimed in claim 1, characterized in that the film-forming agent is a polymer chosen from polyvinyl acetates (homopolymers or copolymers), polyesters, epoxies, polyacrylics (homopolymers or copolymers), polyurethanes, polyamides, cellulose polymers and blends of these compounds.

3. The glass strand as claimed in claim 2, characterized in that the film-forming agent is polyvinyl acetate, an epoxy or a polyurethane.

4. The glass strand as claimed in one of claims 1 to 3, characterized in that the plasticizer, surfactant and dispersant is chosen from organic compounds, such as optionally halogenated, aliphatic or aromatic, polyalkoxylated compounds, polyalkoxylated fatty acid esters and amine compounds, and from inorganic compounds.

5. The glass strand as claimed in one of claims 1 to 4, characterized in that the coupling agent is chosen from hydrolyzable compounds belonging to the group consisting of silanes, siloxanes, titanates, zirconates and blends of these compounds.

6. The glass strand as claimed in one of claims 1 to 5, characterized in that the electrically conductive particles are particles based on graphite and/or carbon black.

7. The glass strand as claimed in claim 6, characterized in that the particles are in the form of a blend of particles having different shapes, preferably two or three shapes.

8. The glass strand as claimed in claim 6 or 7, characterized in that 30 to 60% of the particles have an aspect ratio varying from 5 to 20.

9. The glass strand as claimed in one of claims 6 to 8, characterized in that the size of the particles taken along their largest dimension does not exceed 250 μm, preferably 100 μm.

10. The glass strand as claimed in one of claim 1 to 9, characterized in that the particles consist of a blend of graphite particles and a carbon black powder with a particle size not exceeding 1 μm.

11. The glass strand as claimed in one of claims 1 to 10, characterized in that the dispersant is chosen from cationic, anionic and nonionic compounds.

12. The glass strand as claimed in one of claims 1 to 11, characterized in that the composition further includes a viscosity regulator chosen from carboxymethyl celluloses, guar or xanthan gums, carrageenans, alginates, polyacrylics, polyamides, polyethylene glycols and blends of these compounds.

13. The glass strand as claimed in one of claims 1 to 12, characterized in that the composition further includes, as additives, lubricants, complexing agents and antifoams.

14. The glass strand as claimed in one of claims 1 to 13, characterized in that the amount of size represents 3.5 to 6% by weight of the strand.

15. A sizing composition intended to coat the glass strands as claimed in one of claims 1 to 14, characterized in that it comprises (in % by weight):
2 to 10%, preferably 3 to 8.5%, of at least one film-forming agent;
0.2 to 8%, preferably 0.25 to 6%, of at least one compound chosen from plasticizers, surfactants and dispersants;
4 to 25%, preferably 6 to 20%, of electrically conductive particles;
0.1 to 4%, preferably 0.15 to 2%, of at least one coupling agent;
0 to 4%, preferably 0 to 1.8%, of at least one viscosity regulator; and
0 to 6%, preferably 0 to 3%, of additives.

16. The composition as claimed in claim 15, characterized in that it has a solids content varying from 8 to 35%, preferably 12 to 25%.

17. A method of preparing the composition as claimed in either of claims 15 and 16, which comprises the steps consisting in:
a) producing a dispersion D of the conductive particles in water containing the dispersant;
b) introducing the other components of the size, namely the film-forming agents, the plasticizers, the surfactants, the coupling agents, in hydrolyzed form, and, where appropriate, the viscosity regulators and the additives, in water in order to form an emulsion E; and
c) blending the dispersion D with the emulsion E.

18. The method as claimed in claim 17, characterized in that steps a) and c) are carried out with sufficient stirring to prevent sedimentation of the conductive particles.

19. A composite in which at least one thermosetting polymer material is combined with reinforcing strands, characterized in that said strands consist partly or completely of glass strands as claimed in one of claims 1 to 14.

20. The composite as claimed in claim 19, characterized in that the glass content in the composite is between 5 and 60%.

21. The composite as claimed in either of claims 19 and 20, characterized in that it is in the form of an SMC and in that the glass content is between 10 and 60%, preferably 20 to 45%.

22. The composite as claimed in either of claims 19 and 20, characterized in that it is in the form of a EMC and in that the glass content is between 5 and 20%.

23. The use of the glass strands as claimed in one of claims 1 to 14 for producing electrically conductive molded parts using the technique of compression molding, said strands being used in SMC or BMC form.

24. A class strand mat, characterized in that said strands consist partly or completely of glass strands as claimed in one of claims 1 to 14,

25. A class strand veil, characterized in that said strands consist partly or completely of glass strands as claimed in one of claims 1 to 14.
